(19) United States
(12) Patent Application Publication
(10) Pub. No.: US 2007/0242321 A1
(43) Pub. Date: Oct. 18, 2007

(54) Holographic Recording Medium and Recording and Reproducing Method Thereof

(75) Inventors: Tetsuro Mizushima, Oosaka (JP); Takuya Tsukagoshi, Kanagawa (JP); Hideaki Miura, Tokyo (JP); Jiro Yoshinari, Tokyo (JP)

Correspondence Address: OLIFF & BERRIDGE, PLC, P.O. BOX 19928, ALEXANDRIA, VA, 22320, US

(73) Assignee: TKD CORPORATION, Chuo-ku, Tokyo (JP)

(21) Appl. No.: 10/593,304

(22) PCT Filed: Mar. 22, 2005
(86) PCT No.: PCT/JP05/05115

§ 371 Date: Sep. 18, 2006

(51) Int. Cl. G03H 1/02

(52) U.S. Cl. 359/3

(57) ABSTRACT

A holographic recording medium is superior in moisture resistance, thermal resistance, and rigidity and can certainly detect positional information to carry out a sophisticated recording and reproducing control and a recording and reproducing method thereof. The holographic recording medium 10 is configured to have substrates 12 made of a glass material and a hologram recording layer 14 provided on the substrate 12. Markers 16 are provided on the surface of the substrate 12 as positional information in the hologram recording layer 14.

### TECHNICAL FIELD

The present invention relates to a holographic recording medium and a recording and reproducing method thereof.

### BACKGROUND ART

A holographic recording medium receives attention in recent years as a recording medium with large capacity and high access speed. To record and reproduce such a holographic recording medium, it is known to provide the recording medium itself with an address signal and a servo signal. For example, in Japanese Patent Laid-Open Publication No. 2002-63733 proposed is a technology for forming a concavo-convex pattern on a substrate of the holographic recording medium.

Photopolymer widely used in a recording layer of such a conventionally known holographic recording medium, however, is easily deformed by heat, expanded by hygroscopicity, varied in a refractive index, and the like. Accordingly, there is a problem that the recording medium is deformed or deteriorated during storage and a reproduction characteristic becomes worse.

To solve such a problem, it is conceivable to use a material with high rigidity and weather resistance for forming the substrate of the recording layer. However, there are problems that using the material makes it difficult to form the concavo-convex pattern, grooves, and the like on the substrate and also causes high costs.

### DISCLOSURE OF THE INVENTION

The present invention has been made to solve the abovementioned problems. It is an object of the present invention to provide a holographic recording medium which is superior in moisture resistance, thermal resistance, and rigidity and can certainly detect positional information to be able to carry out a sophisticated recording and reproducing control, and a recording and reproducing method thereof.

The present inventors have conducted intensive studies and consequently found out a holographic recording medium which was superior in moisture resistance, thermal resistance, and rigidity and could certainly detect positional information to be able to carry out a sophisticated recording and reproducing control, and found out a recording and reproducing method thereof.

In summary, the above-described objectives are achieved by the following aspects of the present invention.

(1) A holographic recording medium having a substrate made of a glass material and a hologram recording layer provided on the substrate, wherein a marker is provided on a surface of the substrate, serving as positional information in the hologram recording layer.

(2) The holographic recording medium according to (1), wherein the marker comprises a print layer, and is provided on the surface of the substrate opposite to a side on which the hologram recording layer is provided.

(3) The holographic recording medium according to (1) or (2), wherein the marker is provided on the surface opposite to a side upon which a recording beam or reproduction beam is incident.

(4) The holographic recording medium according to any one of (1) to (3), wherein the hologram recording layer is configured to be sandwiched between two substrates made of a glass material, and at least one of the two substrates is provided with the marker.

(5) The holographic recording medium according to (4), wherein the hologram recording layer is sealed by the two substrates and a sealing layer disposed between the two substrates.

(6) The holographic recording medium according to any one of (1) to (5), wherein an anti-reflection layer for preventing surface reflection of the recording beam or the reproduction beam is formed on at least one of a surface upon which the recording beam or the reproduction beam is incident and an opposite surface.

(7) A holographic recording and reproducing method for recording information as a hologram on a holographic recording medium and reproducing the recorded information, the holographic recording medium having a substrate made of a glass material and a hologram recording layer provided on the substrate and a marker provided on a surface of the substrate as positional information, the method comprising detecting the marker by light with a wavelength different from that of a recording beam or a reproduction beam for recording or reproducing the information.

(8) A holographic recording and reproducing method for recording information as a hologram on a holographic recording medium and reproducing the recorded information, the holographic recording medium having a substrate made of a glass material and a hologram recording layer provided on the substrate and a marker provided on a surface of the substrate as positional information, the method comprising detecting the marker by light with a recording beam or a reproduction beam for recording or reproducing the information.

(9) The holographic recording and reproducing method according to (8), wherein the recording beam or the reproduction beam is positioned by use of the marker.

### BRIEF DESCRIPTION OF THE DRAWINGS

FIG. 1 is a schematic cross sectional side view of a holographic recording medium according to an embodiment.

FIG. 2 is a schematic cross sectional side view in the vicinity of a marker in the holographic recording medium.

FIG. 3 is a longitudinal plan view of the holographic recording medium.

FIG. 4 is a schematic side view showing a signal beam and a reference beam viewed from an arrow IV in FIG. 3.

FIG. 5 is a schematic side view showing a marker detection beam viewed from the arrow IV in FIG. 3.

FIG. 6 is a transversal plan view of the holographic recording medium.

FIG. 7 is a schematic side view showing a signal beam, a reference beam, and a marker detection beam viewed from an arrow VII in FIG. 6.

FIG. 8 is a schematic side view of another example of a holographic recording and reproducing method according to the embodiment.

### BEST MODE FOR CARRYING OUT THE INVENTION

A holographic recording medium according to the present invention has a substrate made of a glass material and a hologram recording layer provided on the substrate. To solve the foregoing problems, a marker is provided on the surface of the substrate as positional information in the holographic recording layer.

A holographic recording medium according to an embodiment of the present invention will be hereinafter described in detail with reference to drawings.

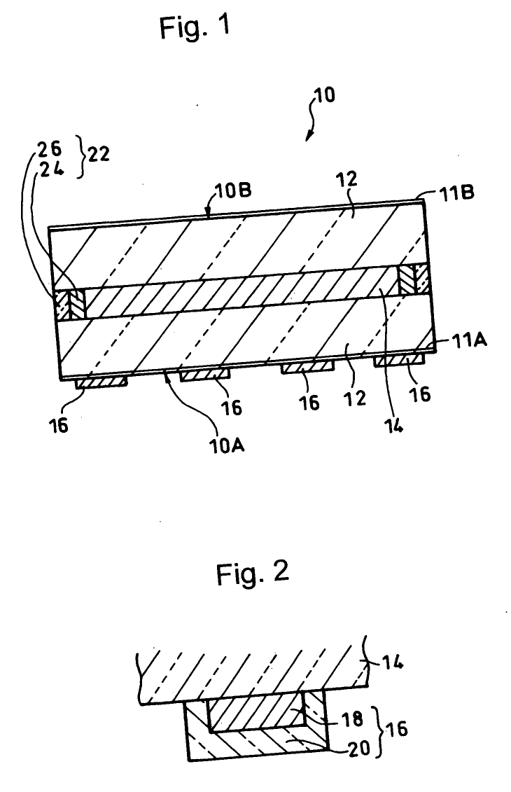

Referring to FIG. 1, a holographic recording medium 10 according to the embodiment of the present invention is configured to include substrates 12 made of a glass material and a hologram recording layer 14 provided on the substrate 12. In this example, two substrates 12 are provided so as to sandwich the hologram recording layer 14. It is preferable that the refractive indexes of the substrate 12 and the hologram recording layer 14 are approximately the same, more specifically the difference between the refractive indexes is less than 0.05.

Markers 16 are provided on the undersurface (the surface of the substrate 12) 10A of the holographic recording medium 10 as positional information in the hologram recording layer 14. In this example, the markers 16 are formed by ink-jet printing with a resolution of 2400 dpi. The undersurface 10A of the holographic recording medium 10 is on a side opposite to a side provided with the hologram recording layer 14 in the substrate 12, and is on a side opposite to a side upon which a recording beam or reproduction beam is incident.

The resolution of the marker 16 by the printing is about several μm at the maximum, but a resolution of about several μm is enough for the record and reproduction of a hologram. In other words, even in adopting a shift multiplex system which makes high density recording possible, a shift pitch of a beam spot of recording beam or production beam is about several tens μm, and hence the markers 16 are available in a pitch at the same level.

As shown in FIG. 2 with enlargement, the marker 16 comprises a pigment layer 18 with a high reflectivity and a protective layer 20 made of a transparent pigment.

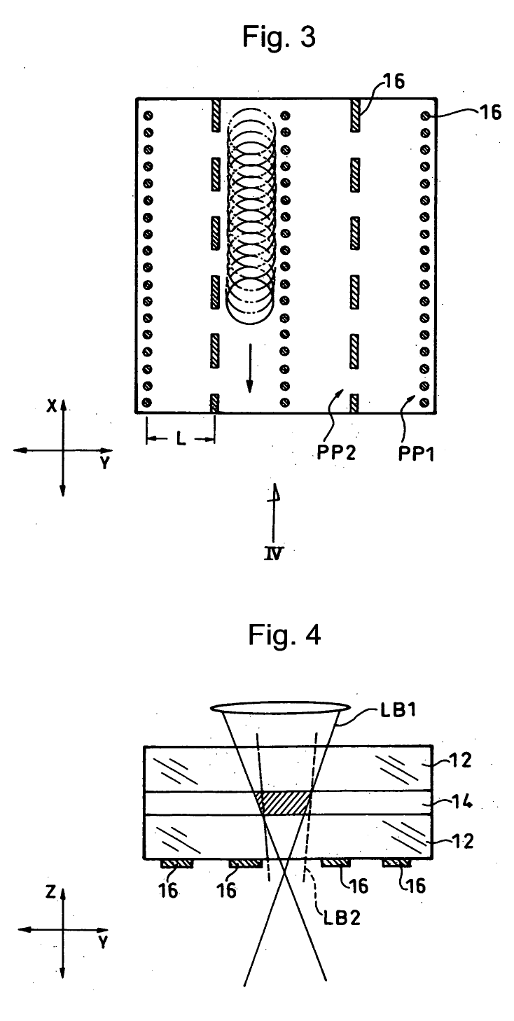

Furthermore, as shown in FIG. 3, the markers 16 are printed in two kinds of patterns, that is, a print pattern PP1 in which a plurality of dots in the shape of an approximately circle are aligned at regular intervals and a print pattern PP2 in which approximately rod shaped lines are aligned at regular intervals in this example. These print patterns PP1 and PP2 are printed along a traveling direction X of the recording beam or the reproduction beam (a circumferential direction when the holographic recording medium 10 is in the shape of a disc) at an established interval L approximately in parallel with each other. As shown in FIG. 4, the interval L between the print patterns PP1 and PP2 is set to a width so that a signal beam LB1 being the recording beam or the reproduction beam and a reference beam LB2 do not pass through the markers 16. In this example, the interval L between the print patterns PP1 and PP2 is approximately 500 μm. It is preferable that the total of the surface area of every print pattern is one-fifth or less of the surface area of the substrate 12, and more preferably one-twentieth or less.

Returning back to FIG. 1, the thickness of the hologram recording layer 14 is about 0.1 mm to several mm. A material containing a monomer material with which photopolymerization reaction can be carried out is used as a material of the hologram recording layer 14, and, for example, photopolymer recording material film made of the monomer material and a matrix material or the like is preferable. The hologram recording layer 14 is sealed with the two substrates 12 and a sealing layer 22 disposed between the two substrates 12.

The sealing layer 22 is composed of a metal foil 24 made of a metal material and a glass block 26 made of a glass material. The sealing layer 22 prevents moisture from penetrating into the hologram recording layer 14 and also functions as a spacer for keeping the distance between the two substrates 12 approximately constant.

Anti-reflection layers (not illustrated) for preventing the surface reflection of the recording beam or the reproduction beam are formed on the top surface 10B and the undersurface 10A of the holographic recording medium 10. The anti-reflection layer in the undersurface 10A may be formed on the substrate before providing the markers 16, or may be formed after providing the markers 16.

The holographic recording medium 10 according to this embodiment has the substrates 12 made of the glass material and the hologram recording layer 14 provided on the substrate 12, and is provided with the markers 16 as positional information in the hologram recording layer 14. Thus, the holographic recording medium 10 is superior in moisture resistance, thermal resistance, and rigidity and can certainly detect the positional information to carry out a sophisticated recording and reproducing control.

To be more specific, since the glass material is superior in the moisture resistance, it is possible to prevent the occurrence of variation in size and a refractive index of the hologram recording layer 14 due to hygroscopicity in advance. The thermal expansion of the glass material is smaller than that of a resin material, so that size does not tend to vary in response to variation in temperature. Furthermore, the glass material is superior in the rigidity, so that it is possible to prevent variation in shape of the holographic recording medium 10 such as warpage.

Furthermore, in hologram recording, when there is an obstacle causing reflection, absorption, aberration, and the like in an optical path, noise may occur and a reproduced image may deteriorate. Forming the markers 16 being the positional information by printing makes it possible to print various print patterns and secure the wide optical path of the recording beam or the reproduction beam. Accordingly, it is possible to certainly detect the positional information and to carry out a sophisticated recording and reproducing control as compared with a conventional holographic recording medium.

The hologram recording layer 14 is sandwiched between the two substrates 12 and the sealing layer 22 disposed between the two substrates 12 seals the hologram recording layer 14, so that it is possible to further certainly protect the hologram recording layer 14.

Furthermore, since the sealing layer 22 functions as the spacer for keeping the distance between the two substrates 12 approximately constant, it is not necessary to provide a spacer separately.

As the markers 16 are provided on the surface 10A opposite to the side upon which a recording beam or reproduction beam is incident, the markers 16 do not block the recording beam or the reproduction beam before being incident on the hologram recording layer 14, then it is possible to prevent reduction in an amount of incident light and the occurrence of noise during recording and reproduction.

Furthermore, the markers 16 are provided on the surface 10A of the substrate 12 opposite to the side upon which the hologram recording layer 14 is provided, so that it is possible to easily form the markers 16.

Furthermore, the anti-reflection layers for preventing the surface reflection of the recording beam or the reproduction beam are formed on the top surface 10B and the undersurface 10A of the hologram recording medium 10. Therefore, it is possible to prevent the occurrence of noise due to the surface reflection.

The shape, structure, and the like of a holographic medium according to the present invention are not limited to those of the holographic medium 10 described in the foregoing embodiment.

Accordingly, for example, there were two kinds of print patterns PP1 and PP2 of the markers 16 in the foregoing embodiment, but the present invention is not limited to it and the kind of print pattern may be one or three or more. The print pattern may have another shape such as, for example, a wave shape.

Furthermore, the markers 16 were printed by the ink-jet printing, but a method of printing the markers 16 is not limited to it. The markers 16 may be printed by screen printing or the like.

The markers 16 were printed on the surface 10A opposite to the side upon which the recording beam or the reproduction beam was incident. The markers 16 may be printed on the surface 10B upon which the recording beam or the reproduction beam is incident.

Furthermore, the marker 16 was composed of the pigment layer 18 and the protective layer 20, but may be composed of only the pigment layer 18. The protective layer 20 may be formed by a method other than printing (for example, spin coating) separately from the pigment layer 18.

In other words, a holographic recording medium according to the present invention has a substrate made of a glass material and a hologram recording layer provided on the substrate and it may have any configuration as long as a marker is provided as the positional information in the hologram recording layer.

Next, a recording (reproducing) method of the holographic recording medium 10 will be described with reference to FIGS. 3 to 7.

To detect the marker of the holographic recording medium 10, a marker detection beam LB3 with a different wavelength from those of a signal beam LB1 and a reference beam LB2 being the recording beam (or the reproduction beam) of a hologram. When the signal beam LB1 and the reference beam LB2 are, for example, blue laser beams with a wavelength of 405 nm, a red laser beam with a wavelength of 650 nm is available as the marker detection beam LB3.

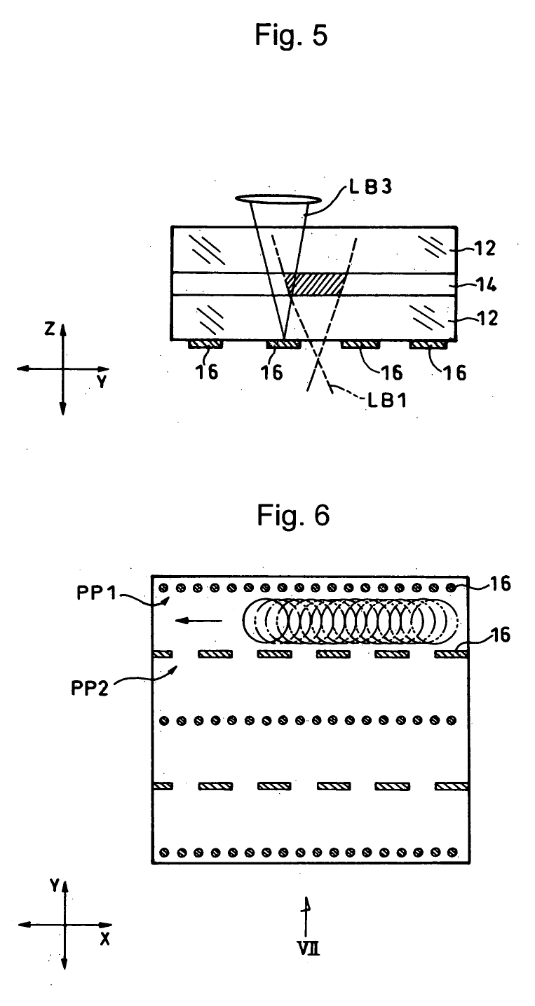

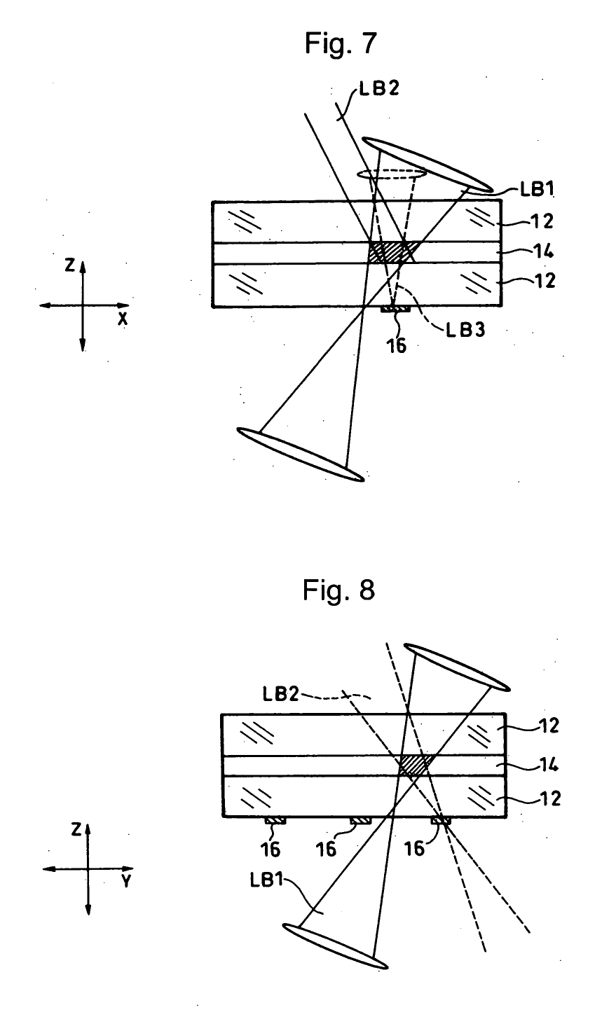

As shown in FIGS. 5 and 7, the marker detection beam LB3 is projected onto the marker 16, and a reflected beam is detected to obtain the positional information in the hologram recording layer 14. To increase precision in the detection of the marker 16, edge detection is preferable to level detection. A hologram is recorded (reproduced) on the basis of the positional information detected like this.

The markers 16 are used for positioning of the recording beam (or the reproduction beam) in a traveling direction X, positioning thereof in a direction Y perpendicular to the traveling direction X (the so-called tracking servo), and also positioning of the holographic recording medium 10 in a thickness direction Z (the so-called focus servo).

In accordance with the holographic recording (reproducing) method according to this embodiment, since the marker 16 is detected by the light with a different wavelength from that of the recording beam (reproduction beam) for recording (reproducing) the hologram, it is possible to restrain the exposure of the hologram recording layer 14. In addition to this, since a light source for the mark detection beam LB3 is separately provided from that of the signal beam LB1 and the reference beam LB2, the recording (reproduction) of the hologram and the detection of the marker 16 can be carried out at the same time.

Since positioning of the recording beam (reproduction beam) is carried out by use of the markers 16, the markers 16 can be used not only an address signal but also a servo signal, so that it is possible to carry out a sophisticated recording and reproducing control.

A holographic recording (reproducing) method according to the present invention is not limited to the holographic recording (reproducing) method according to this embodiment.

In the foregoing embodiment, the marker 16 is detected by the reflection of light, but the present invention is not limited thereto. The marker 16 may be detected by the transmission of light. Accordingly, if the reference beam LB2 being the recording beam (or reproduction beam) is projected onto the marker 16 and the marker 16 is detected by a transmitted beam, as shown in, for example, FIG. 8, it is not necessary to provide a separate light source for detecting the marker 16. Thus, it is possible to realize the miniaturization of a recording and reproducing device of the holographic recording medium 10 with lower cost, and the like.

In this case, if the focus of the reference beam LB2 is set in a printing position of the marker 16, it becomes possible to detect the position of the holographic recording medium 10 in a thickness direction Z during the focusing of the reference beam LB2. In addition to this, the diameter of a beam spot is reduced, so that it is possible to further improve the detection sensitivity of the marker 16. In this case, it is preferable that pigment used in the marker 16 has low reflectivity to the reference beam LB2 and enough absorbs it. For example, at the wavelength of the reference beam LB2, a pigment with a refractive index n=1.52 and an extinction coefficient k=0.05 is available. As a method for detecting the focus, a method for determining a point at which a differential signal of On/Off of the marker 16 becomes maximum is available.

### INDUSTRIAL APPLICABILITY

The holographic recording medium and the recording and reproducing method thereof according to the present invention are superior in moisture resistance, thermal resistance, and rigidity and can certainly detect the positional information to carry out a sophisticated recording and reproducing control.

1. A holographic recording medium having a substrate made of a glass material and a hologram recording layer provided on the substrate, wherein a marker is provided on a surface of the substrate, serving as positional information in the hologram recording layer.

2. The holographic recording medium according to claim 1, wherein the marker comprises a print layer, and is provided on the surface of the substrate opposite to a side on which the hologram recording layer is provided.

3. The holographic recording medium according to claim 1, wherein the marker is provided on the surface opposite to a side upon which a recording beam or reproduction beam is incident.

4. The holographic recording medium according to claim 2, wherein the marker is provided on the surface opposite to a side upon which a recording beam or reproduction beam is incident.

5. The holographic recording medium according claim 1, wherein
the hologram recording layer is configured to be sandwiched between two substrates made of a glass material, and at least one of the two substrates is provided with the marker.

6. The holographic recording medium according to claim 5, wherein the hologram recording layer is sealed by the two substrates and a sealing layer disposed between the two substrates.

7. The holographic recording medium according to claim 1, wherein
an anti-reflection layer for preventing surface reflection of the recording beam or the reproduction beam is formed on at least one of a surface upon which the recording beam or the reproduction beam is incident and an opposite surface.

8. The holographic recording medium according to claim 2, wherein
an anti-reflection layer for preventing surface reflection of the recording beam or the reproduction beam is formed on at least one of a surface upon which the recording beam or the reproduction beam is incident and an opposite surface.

9. The holographic recording medium according to claim 3, wherein
an anti-reflection layer for preventing surface reflection of the recording beam or the reproduction beam is formed on at least one of a surface upon which the recording beam or the reproduction beam is incident and an opposite surface.

10. A holographic recording and reproducing method for recording information as a hologram on a holographic recording medium and reproducing the recorded information, the holographic recording medium having a substrate made of a glass material and a hologram recording layer provided on the substrate and a marker provided on a surface of the substrate as positional information, the method comprising detecting the marker by light with a wavelength different from that of a recording beam or a reproduction beam for recording or reproducing the information.

11. A holographic recording and reproducing method for recording information as a hologram on a holographic recording medium and reproducing the recorded information, the holographic recording medium having a substrate made of a glass material and a hologram recording layer provided on the substrate and a marker provided on a surface of the substrate as positional information, the method comprising detecting the marker by light with a recording beam or a reproduction beam for recording or reproducing the information.

12. The holographic recording and reproducing method according to claim 10, wherein
the recording beam or the reproduction beam is positioned by use of the marker.

13. The holographic recording and reproducing method according to claim 11, wherein
the recording beam or the reproduction beam is positioned by use of the marker.

14. The holographic recording medium according to claim 5, wherein an anti-reflection layer for preventing surface reflection of the recording beam or the reproduction beam is formed on at least one of a surface upon which the recording beam or the reproduction beam is incident and an opposite surface.

15. The holographic recording medium according to claim 6, wherein an anti-reflection layer for preventing surface reflection of the recording beam or the reproduction beam is formed on at least one of a surface upon which the recording beam or the reproduction beam is incident and an opposite surface.
